(19) United States
(12) Patent Application Publication
(10) Pub. No.: US 2008/0233413 A1
(43) Pub. Date: Sep. 25, 2008

(54) POLYPROPYLENE FILMS EMPLOYING RECYCLED COMMERCIALLY USED POLYPROPYLENE BASED FILMS AND LABELS

(75) Inventors: Barry Jason Hostetter, Landenberg, PA (US); Philip F. Welch, Terre Haute, IN (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: APPLIED EXTRUSION TECHNOLOGIES, INC., New Castle, DE (US)

(21) Appl. No.: 12/105,343

(22) Filed: Apr. 18, 2008

Related U.S. Application Data
(63) Continuation-in-part of application No. 11/550,611, filed on Oct. 18, 2006.
(60) Provisional application No. 60/727,726, filed on Oct. 18, 2005.

(51) Int. Cl. B32B 9/04; B32B 27/06; B32B 15/08; B29C 47/00

(52) U.S. Cl. 428/461; 428/411.1; 428/523; 264/141

(57) ABSTRACT

A multilayer film includes a core layer and opposed skin layers. The core layer comprises reclaimed material from the group consisting of a stream of post converted plastic product including inks, with or without an adhesive therein, and a stream of multi-colored plastic bottle caps including multiple polymers therein. at least one of said opposed skin layers being sufficiently opaque to mask any undesired coloration created by the reclaimed material.

Laminations employing the above multilayer film also form part of this invention.

A method of this invention for making a multilayer film including a core layer with recycled plastic therein includes the steps of: separating a plastic film or label from a package of commercial product; pelletizing the plastic film or label into pellets for introduction into an extruder of a film forming device and introducing the pelletized plastic film or label into said extruder for introducing the recycled plastic film or label pellets into a core layer of a multilayer film.

### RELATED APPLICATION

This application is a continuation-in-part of U.S. application Ser. No. 11/550,611, filed on Oct. 18, 2006, which in turn claims the benefit of U.S. Provisional Patent Application Ser. No. 60/727,726, filed Oct. 18, 2005, entitled “Polypropylene Films Employing Recycled Commercially Used Polypropylene Based Films and Labels.” The subject matter of both the '611 application and the '726 application are hereby fully incorporated by reference herein.

### BACKGROUND OF THE INVENTION

This invention relates generally to employing recycled, post-converted polypropylene-based products, e.g., flexible packaging and printed labels, and also plastic bottle caps in polypropylene-based films.

### BACKGROUND ART

It is known to recycle waste material generated in a film-forming extrusion process back into the extruder to thereby effectively use the scrap material in the formation of extruded polypropylene film from which the waste material was generated. For example, scrap material generated in the film-forming process has been introduced into the extruder in a conventional tenter line to thereby incorporate the scrap into the core layer of a multilayer, extruded film, which preferably is biaxially oriented as part of the formation process.

European publication no. 0 470 760, published on Feb. 12, 1992, discloses a composite plastic film including an internal core and outer skin layers. The film is specifically described as being suitable for use as synthetic paper. In the sentence beginning on line 20 of page 4, it is stated that if at least the major polymer components in the core and outer layers are similar, process economics can be improved “by allowing reworking of reclaimed scrap material, eg the sheet edge trims into, eg. the core layer composition.” The '760 publication also discloses the use of a pigment/filler in the outer layers for improving the grip on the film during the stretching operation.

U.S. Pat. No. 6,117,506, issued to Grabowski, discloses a bottle structure in which the outer wall is formed of three layers. Each of the layers includes a colorant, the intermediate layer includes a generally black opaque coloration to block most of the light, and the coloration of the inner and outer layers provides a generally white opaque coloration to mask the black coloration of the intermediate layer.

European Application No. 1 310 357, published on May 14, 2003, discloses the formation of a multilayer (three layer) co-extruded biaxially-oriented pearly synthetic paper label used for integrally molding with a bottle in mold. While this patent discloses that it is known to use titanium oxide in an outer layer of the film, there is no disclosure of including reclaimed material in a core of the film; let alone including reclaimed material from a stream of post converted product including inks and adhesive therein, e.g., flexible packaging and labels, or from a stream of multi-colored plastic bottle caps including multiple polymers.

Young et al. U.S. Pat. No. 5,859,071 discloses the recycling of carpet scrap including more than one polymeric material by first processing the carpet scrap into pellets and then employing the pellets into commercial shaped products. The specific product identified in the examples is an injection molded product. The Young et al. '071 patent does not disclose including any reclaimed material in a core of an extruded film.

Su et al., U.S. Pat. No. 5,286,424, discloses the utilization of recycled polyolefin material from a source that has a chlorine-containing polymer therein, such as polyvinylidene chloride. The major portion of the disclosed invention relates to techniques for separating the chlorine-containing polymer from the remaining components prior to recycling the remaining components. Although there is a general disclosure that the recycled material can be included in films, there is no specific disclosure as to where the recycled material should be introduced into the films. For that matter, there is no disclosure that the films are multilayer structures including an internal core and opposed skin layers. Accordingly, there is no disclosure of including reclaimed material in a core layer of any film; let alone including in a core layer reclaimed material from a stream of post converted product including inks and adhesive therein, e.g., flexible packaging and labels, or from a stream of multi-colored plastic bottle caps including multiple polymers.

Burns et al. U.S. Pat. No. 6,534,189 discloses a uniaxially shrinkable biaxially oriented polypropylene film and a method for use of the film as tobacco pack overwrap. In the paragraph bridging columns 5 and 6, the inventors generally state that the core layer of the film can include recycled polypropylene (RPP).

There is no specific disclosure as to the type or source of polypropylene that is intended to be recycled, as to whether the recycled polypropylene creates a coloration problem, and as to whether the outer layers should include titanium dioxide therein to mask any coloration problem. Moreover, there is no disclosure of including, or employing, reclaimed material from a stream of post converted product including inks and adhesive therein, e.g., flexible packaging and labels, or from a stream of multi-colored plastic bottle caps including multiple polymers.

In a publication from the American Chemistry Council, titled Plastic Packaging Resins, which can be obtained on americanchemistry.com, polypropylene bottle caps and closures are identified by resin code 5, and specifies that such bottle caps and closures are recyclable into a variety of molded products, e.g., battery cases, signal lights, battery cables, brooms and brushes, etc. This article simply identifies possible uses of recycled polypropylene in products, and does not disclose the inclusion of any reclaimed material in a core of any film; let alone including reclaimed material from a stream of post converted product including inks and adhesive therein, e.g., flexible packaging and labels, or from a stream of multi-colored plastic bottle caps including multiple polymers.

In an article identified in the website “www.fixingtheplanet.com/what-can-and-cant-go-your-recycling-bin” various plastics are identified as being recyclable. In the section titled “Plastic # 5: Polypropylene (PP)” on page 2, an initial use of this plastic in forming bottle caps is disclosed. However, this section states that recycling centers almost never take number 5 plastic. This section also identifies a number of recycled products that can be made from number 5 plastics, which all appear to be molded products, i.e., signal lights, battery cables, plates and utensils, razors, brooms, brushes, auto battery cases, ice scrapers, landscape borders, bicycle racks, rakes, bins, pallets, and trays.” There is no disclosure of including reclaimed material in a film, let alone including in a core layer of a multi-layer film a reclaimed material from a stream of post converted product including inks and adhesive therein, e.g., flexible packaging and labels, or from a stream of multi-colored plastic bottle caps including multiple polymers.

In an article appearing at www.idctsr.com/services-6.htm, the section titled “Plastic # 5: Polypropylene (PP)” discloses that bottle caps are a common use for this polymer. Moreover, although stating that difficulties have been encountered in recycling this material, the article states that it's recycling statistics have been improved due to its use in car batteries. There is no disclosure of including reclaimed material in a film, let alone including in a core layer of a multi-layer film a reclaimed material from a stream of post converted product including inks and adhesive therein, e.g., flexible packaging and labels, or from a stream of multi-colored plastic bottle caps including multiple polymers.

In a document identified in “www.alibaba.com/catalog/100197055/Recycle_PP_HDPE.html” it is stated that recycled PP plus HDPE are made from PET bottle caps and labels of mixed color. However, there is no disclosure as to where this recycled material is used.

In an article identified in “www.alibaba.com/catalog/100101138/Recycled_PP_Pellets.html” it is stated that recycled PP from woven bags can be processed into pellets.

There is no disclosure of including these pellets of reclaimed material in any film; let alone including in a core layer of a multi-layer film reclaimed material from a stream of post converted product including inks and adhesive therein, e.g., flexible packaging and labels, or from a stream of multi-colored plastic bottle caps including multiple polymers.

It is known in the prior art to separate polypropylene-based labels from their commercially used PET food and beverage containers prior to recycling the containers to recover the PET for subsequent use in other plastic products. In connection with this recycling process the polypropylene based labels that are separated from the PET plastic containers generally are disposed of by incineration, by being transported to landfills or are by being used in low quality molding applications.

To applicants' knowledge, there has not been any suggestion to recycle into any film, let alone into the core layer of a multi-layer film, reclaimed material from a stream of post converted product including inks and adhesive therein, e.g., flexible packaging and labels, or from a stream of multi-colored plastic bottle caps including multiple polymers.

### SUMMARY OF THE INVENTION

Applicant has discovered products and processes wherein reclaimed material from a stream of post converted products including inks, either with or without an adhesive in said post converted products, e.g., flexible packaging and labels, and/or from a stream of multi-colored plastic bottle caps including multiple polymers therein can be recycled into opaque OPP plastic films, even though inks, adhesives and multi-colored plastics normally provide an undesired visual appearance to plastic films after they are mixed in the recycle processes.

A multilayer film in accordance with this invention includes a core layer and opposed skin layers, said core comprising reclaimed material from the group consisting of a stream of post converted plastic product including inks, with or without an adhesive in said post converted plastic product, and a stream of multi-colored plastic bottle caps including multiple polymers therein, at least one, of said opposed skin layers being sufficiently opaque to mask any undesired coloration created by the reclaimed material.

In a preferred embodiment of this invention, at least one of the opposed skin layers of a multilayer film of this invention is sufficiently opaque to mask any undesired coloration created by the reclaimed material by including a whitening agent or other pigmenting agent therein.

In another preferred embodiment, at least one of the opposed skin layers of a multilayer film of this invention is sufficiently opaque to mask any undesired coloration created by the reclaimed material by being a metal skin layer.

Post converted, flexible packaging and/or label films including printing inks either with or without adhesives therein can be utilized as reclaim material either prior to commercial use or after commercial use. At present, the most common source of flexible packaging and labels is from post converted product prior to being commercially utilized. The films most commonly used as reclaim are polyolefin films that are predominately polypropylene, but can include other polymers such as polyethylene and polybutylene.

The bottle caps can include a variety of polymers and typically are formed either from polypropylene or polyethylene. If the cap includes a liner to provide additional barrier properties a common liner is EVA (ethylene vinyl acetate copolymer). These bottle caps most commonly are employed as reclaim material after commercial use in connection with bottles. Since the bottle caps are not separated by composition and/or color, a stream of bottle caps includes caps of a variety of colors and at least three different polymers, e.g., polypropylene, polyethylene and ethylene vinyl acetate copolymers. Of course other polymers may be included in the caps, and may be in addition to or replace one or more of the above-enumerated polymers.

In the most preferred embodiments of this invention, reclaimed material from a stream of post converted products including inks and, in some cases, adhesives therein, e.g., flexible packaging and labels, or from a stream of multi-colored plastic bottle caps including multiple polymers therein are used as part of the composition of the core layer of a multilayer opaque OPP film. The labels included in the stream of recycled material may be collected as scrap or second quality material subsequent to the label making process, or the labels may be separated from plastic bottles, preferably PET bottles, as part of a typical PET container recycle process. In all cases, the reclaimed material is ground up and melt extruded into pellets for inclusion into at least the core layer of a multilayer, opaque film.

The streams of reclaimed material in accordance with this invention are recycled into extruded pellets using standard film re-extrusion processing techniques. For example, bales of flexible packaging or label stock including inks, either with or without an adhesive in the product and/or multi-color plastic bottle caps including multiple polymers therein are fed into a granulator where large sheets of recycled material are reduced in size to flakes. These flakes are then processed through a densifier to produce compressed pellets of un-melted film. The pellets are fed into an extruder which is equipped with a vacuum vent. Commercial processing aids such as ML1803, a compound of calcium oxide in polyethylene, which is manufactured by ML Plastics GmbH, may also be used. Finally, the melt is pumped through a fine mesh filter and into a standard underwater pelletizer. In some cases the product is directed through a fine mesh filter prior to vacuum venting. In fact, although the use of an extruder with a vacuum vent is preferred, when bottle caps having limited volatile components are being processed into pellets it may not be necessary to employ a vacuum vent.

A typical OPP label stock that is recycled in accordance with this invention is a laminate structure including for example, a multilayer voided opaque film such as AET's 400 WT/L II and a multilayer clear film such as AET's 48 B503-2, with the printing ink and the lamination adhesive located between the opaque and the clear films and with the inks being visible through the clear film.

The commercially used single layer or laminated flexible packaging or label structures that are recycled in accordance with this invention may consist of clear, opaque, metallized or coated films and may be one or more films, in combination, either with or without multi-color plastic bottle caps including multiple polymers therein. For some applications or products it may not be possible or desirable to recycle material that previously was metallized, since the metal content may not be acceptable for use in such applications or products. However, within the broad scope of this invention, the recycled flexible packaging or label structures may include metallized films in the mix.

The formation of the melt extruded pellets can take place either at the site of manufacture of the multilayer, opaque OPP films or at a remote site. Most preferably the resultant multilayer opaque film itself has a wide variety of applications, including use as labels, signs, tags, brochures, posters, etc.

In accordance with this invention a variety of structures and compositions employed in commercial OPP flexible packaging and label applications can be recycled, including structures based on, but not limited to clear, white, metallized or coated films. The streams of reclaimed flexible packaging and label structures most often include inks, lacquers, coatings, and adhesives, which generally have been considered to render them undesirable for use as recycled material in plastic film structures; particularly when a gray tint or hue is unacceptable.

Excluded from use as a reclaim material within the scope of this invention are OPP films or labels employing polyvinylidene chloride homopolymer and/or copolymer coatings. Specifically, polyvinylidene chloride is not compatible with polypropylene-based films into which the plastic films or labels are intended to be recycled. To remove polyvinylidene chloride from the plastic films or labels prior to recycling them would be undesirably costly and therefore economically not feasible.

The benefits of utilizing post-converted and/or used OPP film based flexible packaging and labels as recycled materials in a newly produced OPP film are numerous. It is envisioned that the overall economics for a process that utilizes recycled flexible packaging and labels would operate at a reduced material cost compared to the utilization of all new materials. The other benefit to the use of recycled OPP film based flexible packaging and labels as part of the composition of newly produced OPP films are the environmental benefits from a recycle perspective and enhanced sustainability life cycle. The same benefits of utilizing post-converted and/or used OPP film based flexible packaging and labels as recycled materials, as described above, are obtained by utilizing as reclaim material a stream of multi-color plastic caps including multiple polymers therein.

### DETAILED DESCRIPTION OF THE INVENTION

In accordance with this invention reclaimed material from a stream of post converted product including inks either with or without adhesives in said post converted product, e.g., flexible packaging and labels made from oriented (biaxially ore uniaxially) polypropylene films, and/or from a stream of multi-colored plastic bottle caps including multiple polymers therein are collected and then converted by melt extrusion into pellets. The pellets then are introduced into an extruder for incorporation into the core layer of a new, multilayer, opaque plastic film, either uniaxially oriented or biaxially oriented. The pelletizing operation may take place either at the manufacturing site where the opaque plastic film is extruded, or may take place at a remote site. In this latter case the pellets, after formation, will be transported to the manufacturing site for use in manufacturing the opaque plastic film.

In the embodiments of this invention in which the plastic to be recycled is in the form of label stock including inks, and sometimes adhesives therein, such label stock can be obtained prior to commercial use on packaging, or alternatively, the labels can be separated from commercial packages, such as PET bottles, after commercial use of the packages. The discussion that follows sometimes will be directed only to the use of label stock as the reclaimed material. However, it should be understood that, unless stated otherwise, the discussed use of labels as reclaim material also applies to the use of flexible packaging films and bottle caps, as identified above.

New oriented films made with the recycled label stock of this invention are opaque OPP film structures that can include a single, multilayer, extruded film or a lamination of two or more multilayer, extruded films. The multilayer recycled opaque OPP films can be 2, 3, 5 or more layers produced by coextrusion, extrusion coating, coating, or metallization.

Most preferably each extruded film is a multilayer structure including a voided core and outer opposed skin layers, with the skin layers preferably being substantially thinner than the core layer. Most preferably the recycled label stock, in the form of pellets, is introduced only into the core layer of the multilayer film.

In accordance with the preferred embodiments of this invention, the core layer of the film may be 100% recycled OPP label stock or a blend of between 5-100% recycled OPP label stock combined with virgin or un-recycled polypropylene resin. In the most preferred embodiments the core is voided with any of the well known voiding agents, such as calcium carbonate or one or more of the well known organic voiding agents, such as polybutylene terephthalate. Although the core layer is voided in accordance with the preferred embodiment of this invention, it is within the scope of this invention to form a non-voided core layer with the use of recycled oriented polypropylene label stock.

It is extremely important that one or more of the outer exposed skin layers be sufficiently opaque to mask any undesired visual effect created by the recycled material. In accordance with one aspect of this invention the required opacity is obtained by including a whitening agent, such as titanium oxide, zinc oxide or barium sulfate, or other pigmenting agent, e.g., carbon black or other coloring agent, in said one or more outer exposed skin layers. In accordance with another aspect of this invention the required opacity can be obtained by forming said one or more outer exposed skin layers as a metal layer.

In the most preferred embodiment, one or more of the outer, coextruded skin layer(s) preferably is (are) provided by predominantly virgin polypropylene resin and are pigmented, preferably with a white pigment or other coloring agent, to mask the gray color that generally is imparted to the core by the recycled OPP label stock. The resultant multilayer film may be a three or five layer coextruded film and may be coated, extrusion coated or metallized.

It should be understood that when the structures of this invention are laminates of two or more multilayer film structures, contiguous, internal skin layers to be laminated together do not need to be metal layers and do not need to include either a whitening agent or other pigment therein to mask any discoloration from the reclaimed material because these contiguous skin layers are buried layers of the completed film. However, it is very desirable that one or more of the outer exposed skin layers of the multilayer films be opaque, either by being a metal layer or by including a whitening agent or other pigmenting agent so that any undesired color created by the inclusion of the recycled material in the core of the film will be masked.

Most preferably the polymer of the core layer of the multilayer film(s) of this invention is polypropylene, specifically isotactic (crystalline) polypropylene. The term “polypropylene” includes both propylene homopolymers and copolymers of predominately propylene with ethylene or another α-olefin. The preferred copolymers are crystalline random copolymers of propylene and about 1 to 10% ethylene; more preferably about 1 to 6% ethylene and even more preferably about 1 to 4% ethylene. Reference to “propylene homopolymer” includes, in addition to pure homopolymers, mini-random copolymers of propylene including less than 1% ethylene and more preferably 0.6% ethylene. Applicant has recognized by recycling the label structures into an opaque multilayer oriented polypropylene film, the undesired gray color or hue that otherwise would be created by the recycled label stock is avoided. This benefit is most preferably achieved in an opaque multilayer oriented polypropylene film having a voided core and a reasonably heavy loading of titanium dioxide or other whitening agent in one or more of the opposed outer skin layers.

For example, the opposed outer surfaces of the opaque multilayer films of this invention can be coated with an acrylic-clay matte coating; preferably having a thickness of about 8 gauge. This acrylic-clay matte coating provides a surface that is capable of being printed in a variety of ways that can not be employed on uncoated surfaces. Other coatings for improved printing performance may also be used in concert with the present invention.

Converted OPP film based flexible packaging or label stock, either as scrap or recovered from a post consumer recycle process, and/or multi-color plastic bottle caps including multiple polymers therein are (is) recycled into extruded pellets using standard film re-extrusion processing techniques. For example, bales of flexible packaging or label stock and/or bottle caps are fed, either separately or together, into a granulator in which the recycled material is reduced in size to flakes of approximately ⅛ to ¼ in². These flakes may be processed through a densifier to produce compressed pellets of un-melted film. Heat generated in this process is an important first step in reducing the volatiles from the inks and, when utilized, adhesives in the scrap packaging film and label stock. This may not be important in the pelletizing of bottle caps, which do not generally include significant volatiles.

The pellets are fed into an extruder which is equipped with a vacuum vent and a melt filter. Vacuum venting the extruder is very desirable to further reduce volatiles from the inks and adhesives, when used, as well as moisture and entrained air in the feed. A commercial processing aid, such as ML1803, a compound of calcium oxide in polyethylene, which is manufactured by ML Plastics GmbH, may be fed with the scrap at a 3 wt % level, to aid in reducing the volatiles by chemical reaction. Finally, the melt is pumped through a fine mesh filter and into a standard underwater pelletizer. However, in an extruder employing a vacuum venting system it may be desirable to employ the fine mesh filter prior to, or upstream, of the venting system. Extrusion conditions and standard processing aids can be modified as needed to minimize voids within the final pellets. The final pellets were then dried and volatile levels of <0.5% were measured.

The recycled and extruded pellets are added to the core layer through a pre-blended mixture or through the use of an in-line automated blending system which feeds into the core layer of the extruder. The coextruded layers are fed separately and do not contain the recycled extruded pellets. In an exemplary, but not limiting embodiment of this invention the pellets are formed from a mixture including approximately 40% recycled material and about 60% virgin polypropylene. However, higher recycle percentages may be usable in this invention.

A representative OPP label stock that is recycled in accordance with this invention is a laminate structure including for example, a multilayer voided opaque film such as AET's 400 WT/L II and a multilayer clear film such as AET's 48 B503-2, with the printing ink and the lamination adhesive located between the opaque and the clear films and with the inks being visible through the clear film. The AET films are made by Applied Extrusion Technologies, Inc., having corporate offices in New Castle Del., U.S.A.

The commercially used single layer or laminated flexible packaging or label structures may consist of clear, opaque, metallized or coated films and may be one or more films in combination.

### EXAMPLE 1

### 3 Layer Coextrusion

In a representative embodiment of this invention, a three layer opaque film was produced by a typical biaxial orientation tenter process, which is well known. This example includes a core layer comprising 68%, by weight, of a mini random copolymer of polypropylene including 0.6% ethylene; 22%, by weight, of a batch formulation including 62.5% calcium carbonate, 29.4% polypropylene homopolymer and 7.5% titanium dioxide and 10%, by weight, of printed, recycled labels collected as scrap from a label printing and lamination process. This OPP film based label scrap, which included both printing inks and adhesive, was formed into extruded pellets that were introduced into the barrel of the extruder employed to form the core layer of this example. The recycled pellets also contain 3% ML 1803 manufactured by ML Plastics, which is utilized as a process aid for effective extrusion of printed labels into extruded pellets.

A description of the recycled label extrusion process is detailed as Example 5.

Each of the outer opposed skin layers of this example was 18 gauge and included a master batch identified as WP 814, manufactured by Washington Penn Plastics of Washington, Pa. This WP 814 masterbatch includes 79.9%, by weight, polypropylene mini-random copolymer including 0.6% by weight ethylene therein and 20% titanium dioxide

The multilayer opaque film described in this invention was produced by the well known biaxial orientation tenter process. For example, the polypropylene core resin and associated additives were melted and extruded at 250° C. and the coextruded layers were melted and extruded at 210° C. The three layer coextruded melt was extruded through a flat die into a flat sheet at 8500 gauge thickness onto a revolving, polished and cooled cast drum at 60° C. The cast sheet was then oriented 5.3 times in the machine direction (MD) using a four roll series machine direction orientation with an orientation temperature of 138° C. and subsequently oriented 10.3 times in the transverse direction in the tenter oven at an oven orientation temperature of 169° C. The film was then surface treated on both sides by corona treatment to a level of 40 dynes.

The resultant film was wound onto a roll. Film properties are listed in Table 1.

All film properties were measured by standard testing methods. The opacity was determined by ASTM D589 and the whiteness index was determined by ASTM E313.

The recycled and extruded pellets were added to the core layer through a pre-blended mixture, which feeds into the core layer of the extruder. The coextruded layers are fed separately and do not contain the recycled extruded pellets.

### COMPARATIVE EXAMPLE 2

### 3 Layer Coextrusion

In a comparative example of this invention, a three layer opaque film was produced by the biaxial orientation tenter process. This example included a core layer comprising 75%, by weight, of a mini random copolymer of polypropylene including 0.6% ethylene and 25%, by weight, of a batch formulation including 62.5% calcium carbonate, 29.4% polypropylene homopolymer and 7.5% titanium dioxide.

Each of the outer opposed skin layers in this example was 18 gauge and included a master batch identified as WP 814, manufactured by Washington Penn Plastics of Washington, Pa. This WP 814 masterbatch includes 79.9%, by weight, polypropylene mini-random copolymer including 0.6% by weight ethylene therein and 20% titanium dioxide.

The multilayer opaque film described in this comparative example was produced by the well known, biaxially orientation tenter process. For example, the polypropylene core resin and associated additives were melted and extruded at 250° C. and the coextruded layers were melted and extruded at 210° C. The three layer coextrusion melt was extruded through a flat die into a flat sheet at ˜8500 gauge thickness onto a revolving, polished and cooled cast drum at 60° C. The cast sheet was then oriented 5.3 times in the machine direction (MD) using a four roll series machine direction orientation with an orientation temperature of 138° C. and subsequently oriented 10.3 times in the transverse direction (TD) in the tenter oven at an oven orientation temperature of 169° C. The film was then surface treated on both sides by corona treatment to a level of 40 dynes. The resultant film was wound onto a roll. Film properties are listed in Table 1.

All film properties were measured by standard testing methods. The opacity is determined by ASTM D589 and the whiteness index is determined by ASTM E313.

This example is representative of a typical oriented white polypropylene film without either recycled, converted flexible packaging or label structures including inks and adhesive therein, or multi-color bottle caps including multiple polymers therein being utilized in the core composition.

Table of film data for Examples 1 & 2

| | Example 1 | Example 2 |
|---|---|---|
| Thickness (approximate gauge) | 321 | 359 |
| Yield (in 2/lb) | 14,688 | 13,612 |
| Density (gm/cc) | 0.59 | 0.57 |
| Tappi Opacity (%) | 98 | 95 |
| Whiteness Index | 67 | 90 |
| Tensile Strength, MD/TD (kpsi) | 8.8/16.7 | 9.2/16.7 |
| Elongation, MD/TD (%) | 93/27 | 113/30 |

### LINE EXAMPLE 3

### Two Ply Lamination

In another representative embodiment of this invention, film from Example 1 was used to produce a two film component lamination structure in combination with AET's 400 WHSL three layer OPP coextruded film. In this example, film from Example 1 was laminated to the non print/non white side of the 400 WHSL film to produce a two film component lamination structure. In this example, one of the outer coextruded layers consists of white pigmented formulations from Example 1 and one white layer is from the 400 WHSL film. The 400 WHSL film is designated as being laminated to the “IN” side of the lamination structure.

AET's 400 WHSL film is a three layer coextruded film with a voided core and a white pigmented print skin. This product is approximately 125 gauge thick, has a yield of 40,000 in²/lb, a density of 0.55, a Tappi opacity of 84 and a whiteness index of 86.

The lamination step is carried out by employing any suitable adhesive, such as an acrylic-based adhesive; such adhesives being well known to those skilled in the art. Thus, in the above-described laminated structure the outer skin layers both include 10% titanium dioxide as the whitening agent to mask the otherwise gray appearance that would be imparted to the film by the recycled label stock.

### EXAMPLE 4

### Three Ply Lamination

In another representative embodiment of this invention, a film from Example 1 was used to produce a three film component lamination structure with two of AET's 400 WHSL three layer OPP coextruded films. In this Example, 400WHSL was laminated to each side of Example 1 to produce a three film component lamination structure. In this example, both outer coextruded layers consist of white pigmented formulations from the 400 WHSL film.

The lamination step is carried out by employing any suitable adhesive, such as an acrylic-based adhesive; such adhesives being well known to those skilled in the art. Thus, in the above-described laminated structure the outer skin layers both include 10% titanium dioxide as the whitening agent to mask the otherwise gray appearance that would be imparted to the film by the recycled label stock.

Table of Lamination data for Examples 3 & 4

| | Example 3 | Example 4 |
|---|---|---|
| Thickness (approximate gauge) | 420 | 540 |
| Yield (in 2/lb) | 10,680 | 8,155 |
| Density (gm/cc) | 0.62 | 0.63 |
| Tappi Opacity (%) | 97 | 98 |
| Whiteness Index, In/Out | 84/67 | 85/85 |

### EXAMPLE 5

### Description of Recycled Labels and Bottle Caps Through Extruded Pellet Process

Converted OPP label stock and bottle caps were recycled using standard film re-extrusion processing techniques. Bales of label stock, as described above, or mixed caps were fed into a granulator where large sheets of label stock and caps were reduced in size to flakes of approximately ⅛ to ¼ in². These flakes were then processed through a densifier to produce compressed pellets of un-melted film; however, this densification process may not be required when the stream of scrap material is solely bottle caps. Heat generated in this process is an important first step in reducing the volatiles from the inks and adhesives, when used, in the label stock, but may not be necessary when processing bottle caps having a minimum level of volatiles therein. The pellets were fed into an extruder which was equipped with a vacuum vent and a melt filter. Vacuum venting the extruder is very important to further reduce volatiles from the inks and adhesives, when used, as well as moisture and entrained air in the feed. A commercial processing aid called ML1803, a compound of calcium oxide in polyethylene, which is manufactured by ML Plastics GmbH, may be fed with the scrap at a 3 wt % level, to aid in reducing the volatiles by chemical reaction. Finally, the melt may be pumped through a fine mesh filter and into a standard underwater pelletizer. Extrusion conditions can be modified as needed to minimize voids within the final pellets. The final pellets were then dried and volatile levels of <0.5% were measured. It should be noted that the filtering step may be carried out before the vacuum venting operation.

A representative OPP label stock that was recycled in this example was a laminate structure including a multilayer voided OPP opaque film which was AET's 400 WT/L II and a multilayer OPP clear film which was AET's 48 B503-2, with the printing ink and laminating adhesive being between the opaque and the clear films and with the ink being visible through the clear film.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

What is claimed is:

1. A multilayer film includes a core layer and opposed skin layers, said core layer comprising reclaimed material from the group consisting of a stream of post converted plastic product including inks, with or without an adhesive in said product and a stream of multi-colored plastic bottle caps including multiple polymers therein, at least one of said opposed skin layers being sufficiently opaque to mask any undesired coloration created by the reclaimed material.

2. The multilayer film of claim 1, wherein said at least one of said opposed skin layers includes a whitening agent or other pigmenting agent therein to provide desired opacity.

3. The multilayer film of claim 1, wherein said at least one of said opposed skin layers is a metal layer to provide desired opacity.

4. The multilayer film of claim 1, wherein said post converted plastic product including inks, with or without an adhesive in said product, includes flexible packaging and/or labels.

5. The multilayer film of claim 1, including three or more layers produced with coextrusion, extrusion coating, coating or metallization.

6. A single multilayer film or laminations of films with one or more films containing reclaimed material, said reclaimed material being from the group consisting of a stream of post converted plastic product including inks, with or without an adhesive in said product, and a stream of multi-colored plastic bottle caps including multiple polymers therein.

7. The multilayer film of claim 1, wherein the reclaimed material includes labels that are predominantly polypropylene.

8. The multilayer film of claim 1, wherein said film is predominantly polypropylene.

9. The multilayer film of claim 1, wherein outer, visible skin layers include a whitening agent or other pigmenting agent therein.

10. The multilayer film of claim 1, wherein outer, visible skin layers are metal layers.

11. A method of making a multilayer film including a core layer with recycled plastic therein, said method including the steps of:
a. separating a plastic film or label from a package or commercial product;
b. pelletizing the plastic film or label into pellets for introduction into an extruder of a film forming device;
c. introducing the pellets into said extruder for introducing the pellets into the core layer.

12. The method of claim 11, wherein said package is a PET bottle, further including the step of recycling the PET of the bottle for use in other plastic products

13. A lamination of plastic films comprising two or more films, one of said films being the multilayer film of claim 1 and another of said films comprising a commercial plastic film.

14. The multilayer film of claim 1, wherein said film is an opaque film including a voiding agent in the core layer and a white pigment additive in one or more outer layers.

15. The multilayer film of claim 14 where the voiding agent in the core layer is calcium carbonate or polybutylene terephthalate and the outer layer whitening agent is titanium dioxide.

16. The process of claim 11 wherein the step of pelletizing the flexible film or label includes the step of utilizing a vacuum vent extruder.

17. The process of claim 11 wherein the step of pelletizing the recycled flexible film or label includes the step of utilizing a processing aid.

18. The process of claim 18, wherein the processing aid includes calcium oxide.

19. The multilayer film of claim 1, wherein the reclaimed material comprises multi-colored bottle caps including multiple polymers therein.

20. The multilayer film of claim 1, wherein said film is an opaque film including a voiding agent in the core layer and at least one of said skin layers being a metal layer.
